(19) United States
(12) Patent Application Publication
(10) Pub. No.: US 2026/0142282 A1
(43) Pub. Date: May 21, 2026

(54) METAL-AIR SECONDARY BATTERY

(71) Applicant: NGK INSULATORS, LTD., Nagoya-City (JP)

(72) Inventors: Yukari SAKURAYAMA, Nagoya-Shi (JP); Shiho IWAI, Nagoya-Shi (JP); Naomi HASHIMOTO, Nagoya-Shi (JP); Toshihiro YOSHIDA, Nagoya-Shi (JP)

(73) Assignee: NGK INSULATORS, LTD., Nagoya-City (JP)

(21) Appl. No.: 19/450,953

(22) Filed: Jan. 16, 2026

Related U.S. Application Data
(63) Continuation of application No. PCT/JP2024/030060, filed on Aug. 23, 2024.

(30) Foreign Application Priority Data
Sep. 6, 2023 (JP) 2023-144307

(51) Int. Cl. H01M 12/08; H01M 4/02; H01M 4/48; H01M 4/86; H01M 4/90; H01M 4/92; H01M 50/434; H01M 50/449

(52) U.S. Cl. CPC H01M 12/08; H01M 4/48; H01M 4/8663; H01M 4/9016; H01M 4/926; H01M 50/434; H01M 50/449; H01M 2004/027; H01M 2004/8689

(57) ABSTRACT

Provided is a metal-air secondary battery including a comb tooth-shaped charge air electrode layer including a charge air electrode catalyst, an electrically conductive material, and a binder, a comb tooth-shaped discharge air electrode layer that includes a discharge air electrode catalyst, which is a carbon-based catalyst, and a binder, and that is spaced apart from and interdigitated with the comb tooth-shaped charge air electrode layer in the same plane, a metal negative electrode layer arranged facing a composite air electrode layer composed of the charge air electrode layer and the discharge air electrode layer in the same plane, an electrolytic solution impregnated in the metal negative electrode layer, and a separator interposed between the composite air electrode layer and the metal negative electrode layer so as to be in contact with the composite air electrode layer and isolate the composite air electrode layer from the metal negative electrode layer.

### CROSS-REFERENCE TO RELATED APPLICATIONS

This application is a continuation application of PCT/JP2024/030060 filed Aug. 23, 2024, which claims priority to Japanese Patent Application No. 2023-144307 filed Sep. 6, 2023, the entire contents all of which are incorporated herein by reference.

### BACKGROUND OF THE INVENTION

### 1. Field of the Invention

The present disclosure relates to a metal-air secondary battery.

### 2. Description of the Related Art

One candidate for an innovative battery is a metal-air secondary battery. In a metal-air secondary battery, oxygen as a positive electrode active material is supplied from the air, and the space inside the battery container can thus be utilized to a maximum extent for filling the negative electrode active material, so that in principle a high energy density can be achieved. For example, in a zinc-air secondary battery, zinc is used as a negative electrode active material, an alkaline aqueous solution such as potassium hydroxide is used as an electrolytic solution, and a separator (partition) is used to prevent short circuiting between positive and negative electrodes. During discharge, O₂ is reduced on the air electrode (positive electrode) side to generate OH⁻, while zinc is oxidized at the negative electrode to generate ZnO, as shown in the following reaction formulas.
Positive electrode:
Negative electrode:

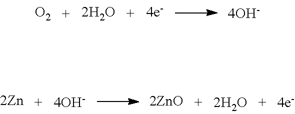

However, it is known that in zinc secondary batteries such as a zinc-air secondary battery or nickel-zinc secondary battery, metallic zinc in dendrite form precipitates from the negative electrode during charging, and that these metallic zinc dendrites can penetrate the voids of a separator such as a nonwoven fabric and reach the positive electrode, resulting in a short circuit. This short circuit due to zinc dendrites may shorten the repeated charge/discharge life. Moreover, another problem with zinc-air secondary batteries is that carbon dioxide in the air passes through the air electrode, dissolves in the electrolytic solution, and precipitates an alkali carbonate, which can reduce battery performance. Similar problems as described above can occur with lithium-air secondary batteries.

In order to deal with the problems described above, a battery including a layered double hydroxide (LDH) separator that blocks the penetration of zinc dendrites while selectively allowing hydroxide ions to pass through has been proposed. For example, Patent Literature 1 (WO2013/073292) discloses a zinc-air secondary battery including an LDH separator provided between an air electrode and a negative electrode in order to prevent both the short circuit between the positive and negative electrodes due to zinc dendrite and the inclusion of carbon dioxide. Patent Literature 2 (WO2016/076047) discloses a separator structure including an LDH separator fitted or joined to a resin outer frame, wherein the LDH separator has a high denseness such that it has a gas impermeability and/or water impermeability. Moreover, Patent Literature 2 also discloses that the LDH separator can be composited with a porous substrate. Further, Patent Literature 3 (WO2016/067884) discloses various methods for forming an LDH dense membrane on a surface of a porous substrate to obtain a composite material (LDH separator). This method includes a step of uniformly adhering a starting material that can impart a starting point for LDH crystal growth to the porous substrate, and hydrothermally treating the porous substrate in a raw material aqueous solution to form an LDH dense membrane on a surface of the porous substrate. Patent Literature 4 (WO2019/124270) discloses a layered double hydroxide (LDH) separator that includes a porous substrate made of a polymer material and an LDH that clogs up the pores of the porous substrate, and has a linear transmittance at a wavelength of 1000 nm of 1% or more.

Further, in a field of metal-air secondary batteries such as a zinc-air secondary battery, an air electrode/separator assembly in which an air electrode layer is provided on an LDH separator has been proposed. Patent Literature 5 (WO2015/146671) discloses an air electrode/separator assembly including an LDH separator and an air electrode layer thereon, the air electrode layer containing an air electrode catalyst, an electron conducting material, and a hydroxide ion conductive material. Moreover, Patent Literature 6 (WO2020/246177) discloses an air electrode/separator assembly including a hydroxide ion conductive separator, an interface layer that covers one side of the separator and includes a hydroxide ion conductive material and an electrically conductive material, and an air electrode layer that is provided on the interface layer and includes an outermost catalyst layer composed of a layered double hydroxide (LDH) covering a porous current collector and the surface thereof. Patent Literature 5 and Patent Literature 6 also disclose the use of LDH as a hydroxide ion conductive material.

There are also LDH-like compounds that, although they cannot be called as LDHs, are similar to LDHs as hydroxides and/or oxides having a layered crystal structure, and such LDH-like compounds are known to exhibit hydroxide ion conductivity at a similar enough level that they can, together with LDH, be collectively called “hydroxide ion conductive layered compounds”. For example, Patent Literature 7 (WO2020/255856) discloses a hydroxide ion conductive separator that includes a porous substrate and a layered double hydroxide (LDH)-like compound that clogs the pores of the porous substrate, in which the LDH-like compound is a hydroxide and/or oxide having a layered crystal structure containing Mg and one or more elements including at least Ti selected from the group consisting of Ti, Y, and Al. Further, Patent Literature 8 (WO2021/229916) discloses an LDH separator that uses an LDH-like compound containing (i) Ti, Y, and optionally Al and/or Mg, and (ii) an additive element M, which is at least one selected from the group consisting of In, Bi, Ca, Sr, and Ba. In addition, Patent Literature 9 (WO2021/229917) discloses an LDH separator containing a mixture of an LDH-like compound and In(OH) 3, in which the LDH-like compound is a hydroxide and/or oxide having a layered crystal structure containing Mg, Ti, Y, and optionally Al and/or In. The separators disclosed in Patent Literature 7 to Patent Literature 9 are said to have superior alkali resistance compared to conventional LDH separators, and to be able to more effectively suppress short circuiting caused by zinc dendrites.

Various types of metal-air secondary batteries that employ a hydroxide ion conductive separator such as an LDH separator have been proposed. For example, Patent Literature 10 (WO2022/209009) discloses a metal-air secondary battery that includes a hydroxide ion conductive separator such as an LDH separator, a catalyst layer that covers one side of the hydroxide ion conductive separator, a gas diffusion electrode provided on the catalyst layer opposite to the hydroxide ion conductive separator side, a metal negative electrode, and an electrolytic solution. In the metal-air secondary battery of Patent Literature 10, the catalyst layer includes an air electrode catalyst, a hydroxide ion conductive material, an electrically conductive material, a binder, and a humidity conditioning agent.

### CITATION LIST

### Patent Literature

Patent Literature 1: WO2013/073292
Patent Literature 2: WO2016/076047
Patent Literature 3: WO2016/067884
Patent Literature 4: WO2019/124270
Patent Literature 5: WO2015/146671
Patent Literature 6: WO2020/246177
Patent Literature 7: WO2020/255856
Patent Literature 8: WO2021/229916
Patent Literature 9: WO2021/229917
Patent Literature 10: WO2022/209009

### SUMMARY OF THE INVENTION

In conventional metal-air secondary batteries like those described above, the same air electrode is typically used for both charging and discharging. However, when a carbon-based discharge catalyst is used for the air electrode, subjecting the discharge catalyst to an oxidation potential (charge potential) causes the carbon-based catalyst to oxidize and deteriorate, resulting in a decrease in discharge potential and an increase in overvoltage.

The inventors have recently discovered that by employing a metal-air secondary battery in which the discharge air electrode layer is spaced apart from and interdigitated with the charge air electrode layer in a comb tooth-shape manner in the same plane, it is possible to prevent the discharge air electrode catalyst (carbon-based catalyst) from being subjected to a charge potential, thereby suppressing the decrease in discharge potential and increase in overvoltage.

Therefore, an object of the present disclosure is to provide a metal-air secondary battery that is capable of suppressing a decrease in discharge potential and an increase in overvoltage even while including a discharge air electrode catalyst that is a carbon-based catalyst.

The present disclosure provides the following aspects.

### [Aspect 1]

A metal-air secondary battery comprising:
a comb tooth-shaped charge air electrode layer comprising a charge air electrode catalyst, an electrically conductive material, and a binder;
a comb tooth-shaped discharge air electrode layer that comprises a discharge air electrode catalyst, which is a carbon-based catalyst, and a binder, and that is spaced apart from and interdigitated with the comb tooth-shaped charge air electrode layer in the same plane;
a metal negative electrode layer arranged facing a composite air electrode layer composed of the charge air electrode layer and the discharge air electrode layer in the same plane;
an electrolytic solution impregnated in the metal negative electrode layer; and
a separator that is interposed between the composite air electrode layer and the metal negative electrode layer so as to be in contact with the composite air electrode layer and isolate the composite air electrode layer from the metal negative electrode layer in a manner that allows hydroxide ions to be conducted between the composite air electrode layer and the metal negative electrode layer.

### [Aspect 2]

The metal-air secondary battery according to aspect 1,
wherein the metal-air secondary battery comprises a pair of the composite air electrode layers that are spaced apart from and facing each other,
the separator is interposed between each of the pair of composite air electrode layers and the metal negative electrode layer, and
the metal negative electrode layer is sandwiched between the pair of composite air electrode layers via the separator.

### [Aspect 3]

The metal-air secondary battery according to aspect 1 or 2, wherein the charge air electrode catalyst is a layered double hydroxide (LDH).

### [Aspect 4]

The metal-air secondary battery according to aspect 3, wherein the LDH as the charge air electrode catalyst comprises at least Ni and Fe as constituent elements.

### [Aspect 5]

The metal-air secondary battery according to aspect 3, wherein the LDH as the charge air electrode catalyst comprises at least Ni, Fe, V, and Co as constituent elements.

### [Aspect 6]

The metal-air secondary battery according to any one of aspects 1 to 5,
wherein the separator is a hydroxide ion conductive separator that isolates the composite air electrode layer from the metal negative electrode layer in a manner that allows hydroxide ions to be conducted between the composite air electrode layer and the metal negative electrode layer, and
the charge air electrode layer further comprises a hydroxide ion conductive material and the discharge air electrode layer further comprises a hydroxide ion conductive material.

### [Aspect 7]

The metal-air secondary battery according to aspect 6, wherein the hydroxide ion conductive separator is a layered double hydroxide (LDH) separator.

### [Aspect 8]

The metal-air secondary battery according to aspect 7, wherein the LDH separator is composited with a porous substrate.

### [Aspect 9]

The metal-air secondary battery according to any one of aspects 6 to 8, wherein the hydroxide ion conductive separator blocks the electrolytic solution from penetrating into the composite air electrode layer so that the electrolytic solution is absent from the air electrode layer.

### [Aspect 10]

The metal-air secondary battery according to any one of aspects 1 to 9, further comprising:
a charge air electrode current collector that is arranged on an outer side of the charge air electrode layer and that extends from an edge of the charge air electrode layer;
a discharge air electrode current collector that is arranged on an outer side of the discharge air electrode layer and that extends from an edge of the discharge air electrode layer; and
a negative electrode current collector that supports the metal negative electrode layer and that extends from an edge of the metal negative electrode layer.

### [Aspect 11]

The metal-air secondary battery according to aspect 10, further comprising:
a charge gas diffusion electrode arranged between the charge air electrode layer and the charge air electrode current collector; and
a discharge gas diffusion electrode arranged between the discharge air electrode layer and the discharge air electrode current collector.

### BRIEF DESCRIPTION OF THE DRAWINGS

FIG. 1 is a schematic front view conceptually showing an example of a metal-air secondary battery according to the present disclosure.

FIG. 2 is a cross-sectional view of the metal-air secondary battery shown in FIG. 1 taken along line 2-2.

FIG. 3 is a cross-sectional view of the metal-air secondary battery shown in FIG. 1 taken along line 3-3.

FIG. 4 is a cross-sectional view of the metal-air secondary battery shown in FIG. 1 taken along line 4-4.

FIG. 5 is a schematic front view showing an example of a holding member used in the metal-air secondary battery shown in FIG. 1.

FIG. 6 is a schematic front view showing a metal-air secondary battery prepared in Examples 1 and 2.

FIG. 7 is a cross-sectional view of the metal-air secondary battery shown in FIG. 6 taken along line 7-7.

FIG. 8 is a cross-sectional view of the metal-air secondary battery shown in FIG. 6 taken along line 8-8.

FIG. 9 is a cross-sectional view of the metal-air secondary battery shown in FIG. 6 taken along line 9-9.

FIG. 10 is a schematic cross-sectional view showing a metal-air secondary battery prepared in Example 3 (comparative example).

FIG. 11 is a graph showing change in discharge potential measured in a charge-discharge test conducted on the metal-air secondary batteries prepared in Examples 1 to 3.

### DETAILED DESCRIPTION OF THE INVENTION

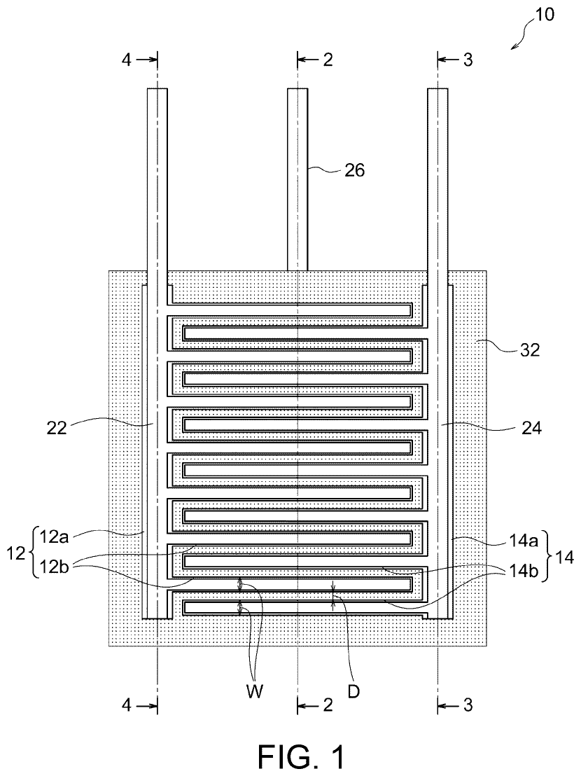

FIG. 1 shows an example of a metal-air secondary battery of the present disclosure. The metal-air secondary battery 10 shown in FIG. 1 includes a charge air electrode layer 12, a discharge air electrode layer 14, a metal negative electrode layer 18, an electrolytic solution (not shown), and a separator 20. The charge air electrode layer 12 and the discharge air electrode layer 14 both have a comb tooth-shape, and are arranged spaced apart from and interdigitating with each other in the same plane. Herein, the combination of the coplanar charge air electrode layer 12 and discharge air electrode layer 14 is referred to as “composite air electrode layer 16.” The charge air electrode layer 12 includes a charge air electrode catalyst, an electrically conductive material, a binder, and optionally a hydroxide ion conductive material. The discharge air electrode layer 14 includes a discharge air electrode catalyst, which is a carbon-based catalyst, a binder, and optionally a hydroxide ion conductive material. The metal negative electrode layer 18 is arranged facing the composite air electrode layer 16. The metal negative electrode layer 18 is impregnated with an electrolytic solution. The separator 20 is interposed between the composite air electrode layer 16 and the metal negative electrode layer 18 so as to be in contact with the composite air electrode layer 16 and isolate the composite air electrode layer 16 from the metal negative electrode layer 18 in a manner that allows hydroxide ions to be conducted between the composite air electrode 16 layer and the metal negative electrode layer 18. Thus, by employing a metal-air secondary battery 10 in which the charge air electrode layer 12 and the discharge air electrode layer 14 are arranged in a comb tooth-shape manner spaced apart from and interdigitating with each other in the same plane, it is possible to prevent the discharge air electrode catalyst (carbon-based catalyst) from being subjected to a charge potential, and to suppress a decrease in discharge potential and an increase in overvoltage.

As described above, conventional metal-air secondary batteries typically use the same air electrode for both charging and discharging. However, when a carbon-based discharge catalyst is used in an air electrode, if subjected to an oxidation potential, the carbon-based catalyst oxidizes and deteriorates, resulting in a decrease in discharge potential and an increase in overvoltage. According to the knowledge of the inventors, when an electrically conductive material (e.g., carbon), a charge catalyst, a hydroxide ion conductive material (e.g., LDH), and a discharge catalyst (e.g., a carbon-based catalyst) are mixed in a single air electrode, the charge potential overlaps the oxidation potential of carbon, making the carbon-based catalyst more susceptible to oxidation and deterioration. It is believed that this oxidation and deterioration of the carbon-based catalyst leads to the decrease in discharge potential and increase in overvoltage. In this regard, according to the present disclosure, by arranging the charge air electrode layer 12 and the discharge air electrode layer 14 in a comb tooth-shape manner spaced apart from and interdigitating with each other in the same plane, it is possible to prevent the discharge air electrode catalyst (carbon-based catalyst) from being subjected to a charge potential, and to suppress oxidation and deterioration of the carbon-based catalyst. That is, because the charge air electrode layer 12 and the discharge air electrode layer 14 are spaced apart from each other despite being in the same plane, the discharge air electrode layer 14 is not subjected to a charge potential even while the charge reaction is occurring in the charge air electrode layer 12, and as a result it is difficult for oxidation and degradation of the carbon-based catalyst to progress. This suppression of a decrease in electrode activity is thought to result in suppression of the decrease in discharge potential and increase in overvoltage.

The charge air electrode layer 12 includes a charge air electrode catalyst, an electrically conductive material, a binder, and optionally a hydroxide ion conductive material. The charge air electrode catalyst has a spherical, platy, or fibrous form, and is dispersed throughout the charge air electrode layer 12. The charge air electrode catalyst may also serve as an electrically conductive material or a hydroxide ion conductive composite material. The charge air electrode catalyst is not particularly limited as long as it has a catalytic activity for the charge reaction. The charge air electrode catalyst can be a hydroxide catalyst, an oxide catalyst, or a carbon-based catalyst, but is preferably a layered double hydroxide (LDH). The LDH used as the charge air electrode catalyst is preferably an LDH including at least Ni and Fe as constituent elements (Ni—Fe-LDH), and more preferably an LDH including at least Ni, Fe, V, and Co as constituent elements (Ni—Fe—V—Co-LDH). Herein, “including . . . as constituent elements” excludes elements contained as impurities, and refers to the metal elements or metal ions forming the hydroxide base layer that constitutes the LDH. The charge air electrode catalyst is preferably in the form of fine particles to increase the reaction field. Specifically, the charge air electrode catalyst has a particle size of preferably 5 μm or less, more preferably 0.5 nm to 3 μm, and further preferably 1 nm to 3 μm.

The discharge air electrode layer 14 includes a discharge air electrode catalyst, which is a carbon-based catalyst, a binder, and, optionally, a hydroxide ion conductive material. The discharge air electrode catalyst has a spherical, platy, or fibrous form, and is dispersed throughout the discharge air electrode layer 14. The discharge air electrode catalyst may also serve as an electrically conductive material or a hydroxide ion conductive composite material. The discharge air electrode catalyst is not particularly limited as long as it is a carbon-based catalyst that has a catalytic activity for the discharge reaction. Herein, “carbon-based catalyst” refers to a catalyst containing carbon, and may be carbon that itself has a catalytic activity, or may be carbon that supports a catalytically active metal or oxide. A preferred example of the carbon-based catalyst is carbon powder that supports a catalyst. Examples of the catalyst supported on carbon powder include (i) a transition metal element such as cobalt and nickel, (ii) a platinum group element such as palladium and platinum, (iii) a perovskite oxide containing a transition metal such as cobalt, manganese, and iron, (iv) noble metal oxides such as ruthenium and palladium, (v) manganese oxide, and (vi) any combination thereof. A platinum group element such as palladium and platinum is particularly preferred, and platinum is most preferred. Another preferred example of the carbon-based catalyst is a carbon powder catalyst in which the carbon itself has discharge activity. Examples of such carbon include (i) nitrogen-doped carbon, (ii) nitrogen-phosphorus-doped carbon, (iii) nitrogen-boron-doped carbon, (iv) nitrogen-sulfur-doped carbon, and (v) any combination thereof. Nitrogen-doped carbon and nitrogen-boron-doped carbon are particularly preferred, and nitrogen-doped carbon is most preferred. The discharge air electrode catalyst is preferably in the form of fine particles to increase the reaction field. Specifically, the discharge air electrode catalyst has a particle size of preferably 5 μm or less, more preferably 0.5 nm to 3 μm, and further preferably 1 nm to 1 μm.

The electrically conductive material contained in the charge air electrode layer 12 is not particularly limited as long as it is a material that can impart electrically conductive properties to the charge air electrode layer 12, but is preferably a carbon-based material, an electrically conductive oxide, or a metal. Examples of the carbon-based material include carbon black, graphite, carbon nanotubes, graphene, reduced graphene oxide, Ketjen black, and arbitrary combinations thereof. The electrically conductive oxide is preferably an electrically conductive ceramic, and preferred examples of the electrically conductive ceramic include LaNiO₃, LaSr₃Fe₃O₁₀, and the like. Preferred examples of the metal include nickel, titanium, and the like. In the discharge air electrode layer 14, because the carbon-based catalyst itself exhibits electrically conductive properties, an electrically conductive material is not essential, but may be added separately from the carbon-based catalyst. In that case, the electrically conductive material is preferably a carbon-based material. Examples of the carbon-based material include carbon black, graphite, carbon nanotubes, graphene, reduced graphene oxide, Ketjen black and arbitrary combinations thereof.

A known binder resin can be used as the binder contained in the charge air electrode layer 12 and the discharge air electrode layer 14. Examples of the binder resin include an acrylate-based resin, a butyral-based resin, a vinyl alcohol-based resin, a cellulose, a vinyl acetal-based resin, polytetrafluoroethylene, polyvinylidene fluoride and the like, and arbitrary combinations thereof, and the binder resin is preferably an acrylate-based resin, a butyral-based resin, polytetrafluoroethylene, polyvinylidene fluoride, or an arbitrary combination thereof. It is preferred that the binder is present in such a manner that it binds the air electrode catalyst, the electrically conductive material, and the optionally-selected hydroxide ion conductive composite material to each other and that these components are adequately exposed so that they can come into contact with air.

The charge air electrode layer 12 and/or the discharge air electrode layer 14 may optionally contain a hydroxide ion conductive material. In this case, the hydroxide ion conductive material has a spherical, platy, or strip-like form, and forms a conductive path throughout the catalyst layer. The hydroxide ion conductive material is not particularly limited as long as it has hydroxide ion conductivity, but LDH is preferred. The composition of the LDH is not particularly limited, but a preferred LDH has a basic composition with the formula: M²⁺₁₋ₓM³⁺ₓ(OH)₂Aⁿ⁻_{x/n}·mH₂O (wherein M²⁺ is at least one kind of divalent cation, M³⁺ is at least one kind of trivalent cation, Aⁿ⁻ is an n-valent anion, n is an integer of 1 or more, x is 0.1 to 0.4, and m is any real number). In the above formula, M²⁺ can be any divalent cation, and preferred examples include Ni²⁺, Mg²⁺, Ca²⁺, Mn²⁺, Fe²⁺, Co²⁺, Cu²⁺, and Zn²⁺. M³⁺ can be any trivalent cation, and preferred examples include Fe³⁺, Al³⁺, Co³⁺, Cr³⁺, and In³⁺. In particular, in order for the LDH to have both a catalytic performance and hydroxide ion conductivity, it is desirable that M²⁺ and M³⁺ are each a transition metal ion. From this viewpoint, more preferably M²⁺ is a divalent transition metal ion such as Ni²⁺, Mn²⁺, Fe²⁺, Co²⁺, or Cu²⁺, and particularly preferably Ni²⁺, while more preferably M³⁺ is a trivalent transition metal ion such as Fe³⁺, Co³⁺, or Cr³⁺, and particularly preferably Fe³⁺. In this case, a portion of M²⁺ may be substituted with a metal ion other than a transition metal, such as Mg²⁺, Ca²⁺, or Zn²⁺, or a portion of M³⁺ may be substituted with a metal ion other than a transition metal, such as Al³⁺ or In³⁺. Aⁿ⁻ can be any anion, but preferred examples include NO₃₋, CO₃²⁻, SO₄²⁻, OH⁻, Cl⁻, I⁻, Br⁻, and F⁻, and more preferably NO₃₋ and/or CO₃²⁻. Therefore, in the above general formula, it is preferred that M²⁺ includes Ni²⁺, M³⁺ includes Fe³⁺, and Aⁿ⁻ includes NO₃₋ and/or CO₃²⁻. n is an integer of 1 or more, preferably 1 to 3. x is 0.1 to 0.4, preferably 0.2 to 0.35. m is any real number. More specifically, m is 0 or more, and typically is a real number or integer of greater than 0 or 1 or more.

The hydroxide ion conductive material may be a hydroxide ion conductive composite material that includes hydrophilic fibers and a plurality of hydroxide ion conductive particles that are interconnected with each other and supported on a surface of the hydrophilic fibers. The “plurality of hydroxide ion conductive particles that are interconnected with each other and supported” can be specified as the hydroxide ion conductive particles that are supported on the surface of the hydrophilic fibers and that are in contact with an adjacent hydroxide ion conductive particle in at least one location. The hydrophilic fibers are not particularly limited as long as hydroxyl groups (OH groups) are coordinated or can be coordinated to the surface of the hydrophilic fibers. The hydroxide ion conductive particles (for example, LDH platy particles) can be synthesized and supported on the surface of such hydrophilic fibers by a coprecipitation method or the like so that they are interconnected with each other (for example, so that the faces of the LDH platy particles are parallel to each other) on the surface of the hydrophilic fibers. That is, by using the hydrophilic fibers, the hydroxide ion conductive particles (for example, LDH platy particles) can be made into a continuous body (i.e., an aggregate of particles that are continuously interconnected with each other in a planar direction). This is thought to be because the hydroxyl groups (OH groups) coordinated to the surface of the hydrophilic fibers change into a form (O-group) in which the hydrogen ion has been removed by the action of a strong base such as NaOH during coprecipitation, for example, and the formed O-groups are then electrostatically attracted to the metal ions in the raw material aqueous solution containing the constituent elements of the LDH, resulting in the precipitation of LDH platy particles on the surface. Preferred examples of the hydrophilic fibers include cellulose nanofibers, chitin nanofibers, chitosan nanofibers (CNF), and combinations thereof, and more preferably cellulose nanofibers (CNF). The length of the hydrophilic fibers is not particularly limited, but is preferably from 0.1 to 100 μm, more preferably from 0.1 to 50 μm, further preferably from 0.2 to 50 μm, particularly preferably from 5 to 50 μm, and most preferably from 10 to 50 μm. That is, the hydrophilic fibers can be short (e.g., several hundreds of nm) or long (e.g., several tens of μm) in fiber length depending on the size of the raw material obtained, but a longer fiber length is preferred. This is because it is thought that a longer fiber length increases the hydroxide ion conduction distance, so that the hydroxide ions are sufficiently distributed throughout the charge air electrode layer 12 without interruptions to the hydroxide ion conduction paths required for the charge/discharge reaction in the charge air electrode layer 12. The hydroxide ion conductive particles are not particularly limited as long as they are particles having hydroxide ion conductivity, but as described above, they are preferably composed of a layered double hydroxide (LDH). In this case, the hydroxide ion conductive particles can be LDH platy particles. The LDHs that make up the hydroxide ion conductive particles preferably contain at least two elements selected from the group consisting of Ni, Fe, Mg, Al, and Ti as constituent elements, and it is more preferable that these at least two elements include Mg and Al. By including at least the two elements Mg and Al, better anion conductivity (e.g., hydroxide ion conductivity) can be realized. In this case, the atomic ratio of Al/Mg determined by energy dispersive X-ray spectroscopy (EDX) of Mg—Al-LDH is preferably 0.30 to 0.55, and more preferably 0.40 to 0.55. When Mg—Al-LDH having an atomic ratio within this range is used as the hydroxide ion conductive material for the air electrode of a metal-air battery, the hydroxide ion conductivity can be particularly effectively improved, and as a result, the reaction rate of the charge/discharge reaction can be further increased and charge/discharge overvoltage can be further reduced. In the LDH, the anion between the layers is preferably a hydroxide ion. That is, the LDH is preferably represented by the formula [M²⁺₁₋ₓM³⁺ₓ(OH)₂][Aⁿ⁻_{x/n}·zH₂O] (wherein M²⁺ includes Mg²⁺, M³⁺ includes Al³⁺, Aⁿ⁻_{x/n} is OH⁻, 0.2≤x≤0.4, and z is any real number exceeding 0). The LDH can be synthesized by coprecipitation. For example, this may be performed by adding a raw material aqueous solution containing the constituent elements of the LDH dropwise into an aqueous solution containing carbonate ions and a fiber material such as cellulose nanofiber (CNF) under a pH condition of from 9.5 to 12, and carrying out a hydrothermal treatment. For example, an aqueous NaOH solution may be used to adjust the pH. The crystal size, crystallinity and/or orientation of the resulting reaction product may be controlled by performing an aging treatment such as stirring, heating and pressurization as necessary.

If the charge air electrode layer 12 and/or the discharge air electrode layer 14 contain a hydroxide ion conductive material, the content of the hydroxide ion conductive material is preferably an amount that allows ion conducting paths to be formed within the charge air electrode layer 12.

The charge air electrode layer 12 or discharge air electrode layer 14 can be produced by preparing a paste containing the air electrode catalyst, binder, and, optionally, electrically conductive material and/or hydroxide ion conductive composite material, and applying the paste onto the surface of the hydroxide ion conductive separator, such as an LDH separator. The paste can be prepared by appropriately adding an organic polymer (binder resin) and an organic solvent to a mixture of the air electrode catalyst and optional electrically conductive material and/or hydroxide ion conductive composite material, and using a known kneader such as a three-roll mill or jet mill. Preferred examples of the organic solvent include alcohols such as butyl carbitol and terpineol, acetic acid ester-based solvents such as butyl acetate. The comb tooth-shaped application of the paste onto the hydroxide ion conductive separator can be carried out by printing. This printing can be carried out by various known printing methods, but a screen printing method is preferred. Alternatively, a clay-like mixture containing the air electrode catalyst, binder, and, optionally, electrically conductive material and/or hydroxide ion conductive material may be prepared, and the mixture rolled using a roll press or similar. The obtained rolled sheet may then be dried and processed into a comb-tooth shape using a laser processing machine or similar.

Both the charge air electrode layer 12 and the discharge air electrode layer 14 are formed in a comb-tooth shape. Specifically, the charge air electrode layer 12 and the discharge air electrode layer 14 each have a busbar air electrode 12a, 14a and a plurality of air electrode fingers 12b, 14b extending from the busbar air electrode 12a, 14a in a comb-tooth shape. The plurality of air electrode fingers 12b, 14b are spaced apart from and interdigitating with each other in the same plane. Therefore, the plurality of air electrode fingers 12b, 14b are arranged so that the air electrode fingers 12b of the charge air electrode layer 12 and the air electrode fingers 14b of the discharge air electrode layer 14 alternate in a direction perpendicular to the direction in which the air electrode fingers 12b, 14b extend.

A width W of each of the air electrode fingers 12b, 14b of the charge air electrode layer 12 or discharge air electrode layer 14 is not particularly limited as long as charge and discharge are possible. In the metal negative electrode layer 18 arranged facing the composite air electrode layer 16 (i.e., the charge air electrode layer 12 and the discharge air electrode layer 14), it is desirable that there is little unevenness in the comb-tooth shape of the zinc produced during charge and zinc oxide produced during discharge. From this viewpoint, the width W of each of the air electrode fingers 12b, 14b is preferably 8 mm or less, more preferably 0.05 to 5 mm, and even more preferably 0.1 to 4 mm. Normally, the charge reaction occurs at the negative electrode portion of the metal negative electrode layer 18 facing the charge air electrode layer 12, and the discharge reaction occurs at the negative electrode portion facing the discharge air electrode layer 14. However, by setting the width W of the air electrode fingers 12b, 14b to a suitable width as described above, the charge and discharge reactions can continue using the negative electrode active material in the negative electrode portion away from the negative electrode portion facing each air electrode finger 12b, 14b.

A separation distance D between the air electrode fingers 12b, 14b of the charge air electrode layer 12 or discharge air electrode layer 14 is not particularly limited as long as the air electrode fingers 12b, 14b are spaced apart from and interdigitated with each other. However, in the metal negative electrode layer 18, it is desirable that there is little unevenness in the comb-tooth shape of the zinc produced during charge and zinc oxide produced during discharge. From this viewpoint, the separation distance D between adjacent air electrode fingers 12b, 14b (i.e., the distance from the side edge of a charge air electrode finger 12b to the side edge of a discharge air electrode finger 14b) is preferably 4 mm or less, more preferably 0.05 to 3 mm, and further preferably 0.1 mm to 2 mm. By arranging the air electrode fingers 12b, 14b at such a suitable separation distance D, the charge and discharge reactions can be continued using the negative electrode active material in the negative electrode portion away from the negative electrode portion facing each air electrode finger 12b, 14b.

“Composite air electrode layer 16” refers to a combination composed of a charge air electrode layer 12 and a discharge air electrode layer 14 that are in the same plane. The charge air electrode layer 12 and the discharge air electrode layer 14 both have a comb-tooth shape, and are spaced apart from and interdigitated with each other the same plane, and thus are not in contact with each other. Therefore, the composite air electrode layer 16 is not a single continuous layer, but rather is a combination of pairs of spaced-apart charge air electrode layers 12 and discharge air electrode layers 14.

The metal negative electrode layer 18 is arranged facing the composite air electrode layer 16. The metal negative electrode layer 18 may be appropriately selected depending on the type of the metal-air secondary battery from metal negative electrodes having a known composition. For example, in the case of a zinc-air secondary battery, the metal negative electrode layer 18 contains at least one material selected from the group consisting of zinc, zinc oxide, zinc alloys, and zinc compounds. That is, the zinc may be contained in any form of zinc metal, zinc compound, or zinc alloy, as long as it has an electrochemical activity suitable for a negative electrode. Preferred examples of the negative electrode material include zinc oxide, zinc metal, calcium zincate, and the like, and a mixture of zinc metal and zinc oxide is more preferred. The metal negative electrode layer 18 may be constructed in a clay-like or gel-like form, or may be mixed with an electrolytic solution to form a negative electrode composite material. For example, a gel negative electrode can be easily obtained by adding an electrolytic solution and a thickener to the negative electrode active material.

The electrolytic solution (not shown) is impregnated into the metal negative electrode layer 18. Further, if the separator 20 is a liquid-permeable separator (i.e., is not a liquid-impermeable hydroxide ion conductive separator), the separator 20 and the composite air electrode layer 16 are also impregnated with the electrolytic solution. The electrolytic solution can be any of the various aqueous electrolytic solutions commonly used in metal-air secondary batteries such as a zinc-air secondary battery, and in particular an alkaline electrolytic solution may be used. Examples of the electrolytic solution include an aqueous solution of an alkali metal hydroxide such as potassium hydroxide and sodium hydroxide, an aqueous solution containing zinc chloride or zinc perchlorate, and the like. Among these, an aqueous solution of an alkali metal hydroxide, particularly an aqueous solution of potassium hydroxide, is preferred, and an aqueous solution of potassium hydroxide having a concentration of 6 to 9 mol/L is more preferred. To suppress the self-dissolution of zinc alloy, a zinc compound such as zinc oxide or zinc hydroxide may be dissolved in the electrolytic solution. For example, zinc oxide may be dissolved in the electrolytic solution until it reaches saturation.

The separator 20 is interposed between the composite air electrode layer 16 and the metal negative electrode layer 18 so as to be in contact with the composite air electrode layer 16 and isolate the composite air electrode layer 16 from the metal negative electrode layer 18 in a manner that allows hydroxide ions to be conducted between the composite air electrode layer and the metal negative electrode layer. The separator 20 is not particularly limited as long as it can prevent electrical contact between the composite air electrode layer 16 and the metal negative electrode layer 18 and allow hydroxide ions to move between the composite air electrode layer 16 and the metal negative electrode layer 18. Various separators such as a microporous membrane separator, a nonwoven fabric separator, a cellulose separator, a hydroxide ion conductive separator, and the like, which will be described later, can be used.

A preferred separator 20 is a hydroxide ion conductive separator. A hydroxide ion conductive separator is defined as a separator that contains a hydroxide-ion-conductive solid electrolyte and that selectively allows hydroxide ions to pass therethrough solely by utilizing hydroxide ion conductivity. A preferred hydroxide ion conductive solid electrolyte is a layered double hydroxide (LDH) and/or an LDH-like compound. Therefore, the hydroxide ion conductive separator is preferably an LDH separator. Herein, “LDH separator” is defined as a separator containing an LDH and/or LDH-like compound, which selectively allows hydroxide ions to pass therethrough solely by the hydroxide ion conductivity of the LDH and/or LDH-like compound. Herein, “LDH-like compound” refers to a hydroxide and/or oxide having a layered crystal structure that, although it might not be called as an “LDH”, does have hydroxide ion conductivity, and can be considered equivalent to an LDH. So, in a broad sense, “LDH” can be construed as encompassing not only LDHs, but LDH-like compounds as well. The LDH separator is preferably composited with a porous substrate. Therefore, the LDH separator preferably further includes a porous substrate, and is composited with the porous substrate in a form in which the pores of the porous substrate are filled with the LDH and/or LDH-like compound. That is, in a preferred LDH separator, the pores of the porous substrate are clogged up by the LDH and/or LDH-like compound so as to exhibit hydroxide ion conductivity and gas impermeability (and therefore function as an LDH separator exhibiting hydroxide ion conductivity). The porous substrate is preferably made of a polymer material, and it is particularly preferred that the LDH and/or LDH-like compound is incorporated throughout the entire thickness of the porous substrate made of a polymer material. For example, known LDH separators such as those disclosed in Patent Literature 1 to Patent Literature 10 can be used. The thickness of the LDH separator is preferably from 5 to 100 μm, more preferably from 5 to 80 μm, further preferably from 5 to 60 μm, and particularly preferably from 5 to 40 μm.

When the separator 20 is a hydroxide ion conductive separator (e.g., an LDH separator), it is preferred that the charge air electrode layer 12 contain a hydroxide ion conductive material and the discharge air electrode layer 14 contain a hydroxide ion conductive material. The hydroxide ion conductive materials that can be used for the air electrode layers 12, 14 are as described above. That is, because a hydroxide ion conductive separator (e.g., an LDH separator) has a dense structure that does not allow the electrolytic solution to pass through, the hydroxide ion conductive separator blocks the electrolytic solution from penetrating into the composite air electrode layer 16, which means that electrolytic solution is not present in the composite air electrode layer 16. In other words, in the composite air electrode layer 16, the electrolytic solution cannot be used as a hydroxide ion conductive medium. Therefore, by including a hydroxide ion conductive material into the charge air electrode layer 12 and the discharge air electrode layer 14, hydroxide ion conduction paths can be secured.

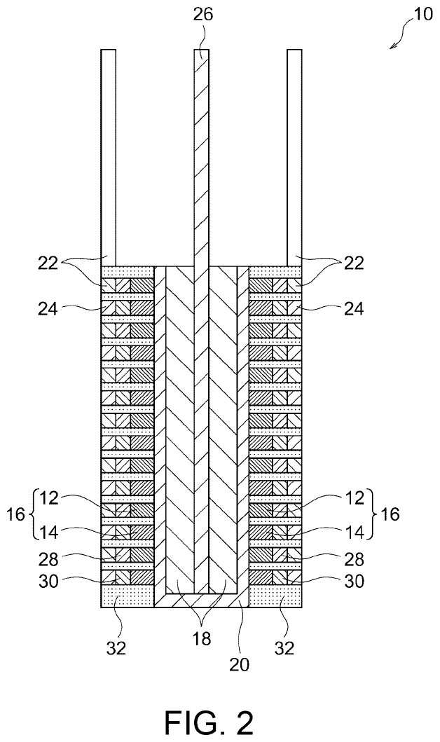

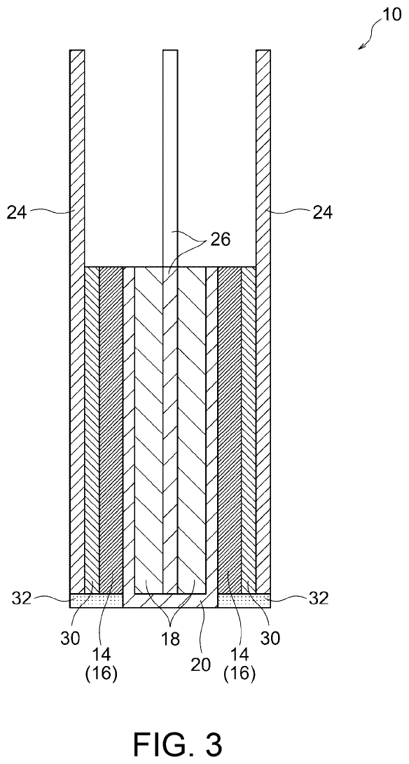

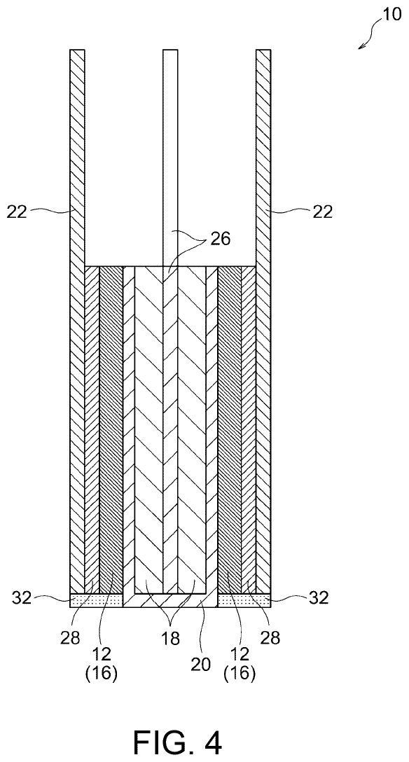

Further, when the separator 20 is a hydroxide ion conductive separator (e.g., an LDH separator), the separator 20 is preferably provided so as to cover not only both surfaces but also the edge surfaces (excluding the upper edge surface) of the metal negative electrode layer 18, as shown in FIGS. 2 to 4. In other words, covering or enveloping the entire metal negative electrode layer 18 with the hydroxide ion conductive separator (e.g., an LDH separator) is preferable in terms of the point that short circuiting caused by zinc dendrites can be more effectively suppressed.

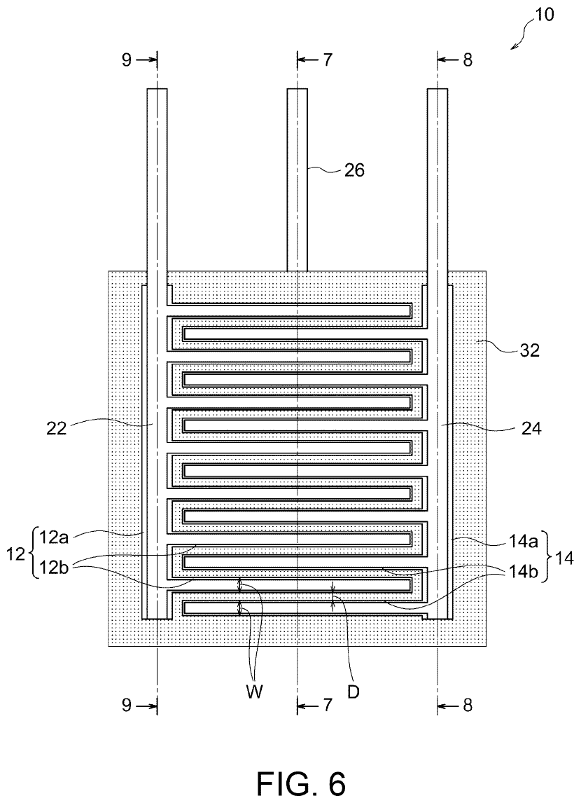

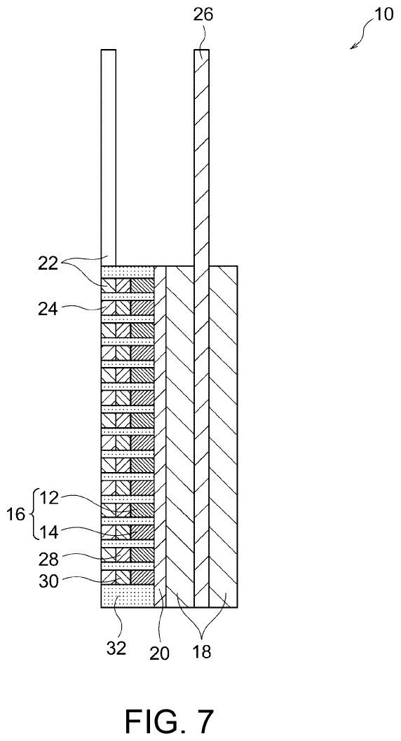

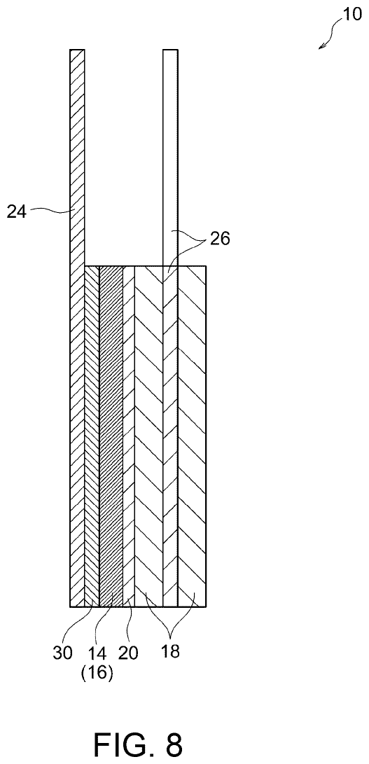

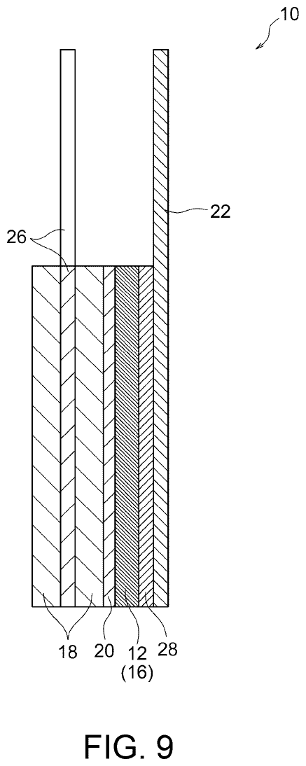

As shown in FIGS. 1 to 4, a configuration in which the metal negative electrode layer 18 is sandwiched between a pair of composite air electrode layers 16 is preferred because such a configuration allows for the composite air electrode layers 16 to be arranged on both sides of the metal-air secondary battery 10 to effectively use space. That is, according to a preferred aspect of the present disclosure, the metal-air secondary battery 10 includes a pair of composite air electrode layers 16 that oppose each other at a distance, and the separator 20 is interposed between each pair of composite air electrode layers 16 and the metal negative electrode layer 18, and the metal negative electrode layer 18 is sandwiched between pairs of composite air electrode layers 16 via the separator 20. However, the metal-air secondary battery 10 of the present disclosure is not limited to this configuration, and may instead have a configuration in which the composite air electrode layer 16 is provided on only one side of the metal negative electrode layer 18, as shown in FIGS. 6 to 9 described below.

Preferably, a charge air electrode current collector 22 is provided on an outer side of the charge air electrode layer 12, and extends from the edge of the charge air electrode layer 12 (e.g., upward or laterally), while a discharge air electrode current collector 24 is provided on an outer side of the discharge air electrode layer 14, and extends from the edge of the discharge air electrode layer 14 (e.g., upward or laterally). It is preferred that the air electrode current collectors 22, 24 are arranged in the same comb tooth-shape manner on the comb tooth-shape portions of the air electrode layers 12, 14. The air electrode current collectors 22, 24 can be made of a common porous material that is electrically conductive, and preferably are made of metal. Preferred examples of the metal forming the air electrode current collectors 22, 24 include stainless steel, titanium, nickel, brass, copper, and the like. When made of metal, the form of the air electrode current collectors 22, 24 is not particularly limited as long as the air electrode current collectors 22, 24 are electrically conductive and allow air to pass through. Preferred examples include a porous metal, a metal mesh, and a metal plate having an uneven shape. Examples of the porous metal include a metallic product having open pores, such as a foamed metal and a sintered porous metal. Examples of the metal mesh include a laminate product of a metal mesh or a metal mesh in laminated form. A porous metal plate such as a punched metal that has been processed into a wavy shape may be used as the metal plate having an uneven shape.

Preferably, a negative electrode current collector 26 is provided that supports the metal negative electrode layer 18 and extends (e.g., upward or laterally) from the edge of the metal negative electrode layer 18. Preferred examples of the negative electrode current collector include a metal plate or mesh of stainless steel, copper (e.g., copper punched metal), nickel, and the like, carbon paper, an oxide conductor, and the like. For example, a negative electrode plate composed of a metal negative electrode layer 18/negative electrode current collector 26 can be preferably prepared by applying a mixture containing zinc oxide powder and/or zinc powder, and, optionally, a binder (e.g., polytetrafluoroethylene particles), onto a copper punched metal. At that time, it is also preferred to press the dried negative electrode plate (i.e., the metal negative electrode layer 18/negative electrode current collector 26) to prevent the electrode active material from falling off and improve electrode density.

Optionally, a charge gas diffusion electrode 28 may be provided between the charge air electrode layer 12 and the charge air electrode current collector 22, and a discharge gas diffusion electrode 30 may be provided between the discharge air electrode layer 14 and the discharge air electrode current collector 24. It is preferred that the gas diffusion electrodes 28, 30 are also arranged in a comb tooth-shape manner on the comb tooth-shape portions of the air electrode layers 12, 14. It is preferred that the gas diffusion electrodes 28, 30 include a microporous layer (MPL) and a substrate for gas diffusion, and are formed on one side of the air electrode layers 12, 14 so that the microporous layer (MPL) is in contact with the air electrode layers 12, 14. The substrate for gas diffusion is not particularly limited as long as it has electron conductivity and is a porous material that can diffuse oxygen throughout the electrode, and is preferably carbon paper or a porous metallic body. From the viewpoint of reducing energy density while securing gas diffusivity, the thickness of the substrate for gas diffusion is preferably 0.4 μm or less, and more preferably 0.1 to 0.3 μm. The porosity of the substrate for gas diffusion is, from the viewpoint of the permeation amount of the gas, preferably 70% or more, more preferably from 70 to 90%, and particularly preferably from 75 to 85%. The porosity values described above enable securing both excellent gas diffusibility and a wide reaction region. Moreover, the generated water is less likely to clog up pores due to the large pore spaces. The porosity can be measured by a mercury intrusion method. The microporous layer is not particularly limited as long as it has electron conductivity and water repellency to an extent that water generated by an air electrode reaction does not penetrate into the substrate for gas diffusion, but preferably contains a carbon material and polytetrafluoroethylene (PTFE).

As described above, it is preferred that the air electrode layers 12, 14 include comb tooth-shape portions, and the gas diffusion electrodes 28, 30 and/or air electrode current collectors 22, 24 are arranged in the same comb tooth-shape manner on those comb tooth-shape portions. To easily realize such a complex structure, it is preferred that the metal-air secondary battery 10 include a holding member 32 having comb tooth-shape openings 32a capable of accommodating the comb tooth-shape air electrode layers 12, 14, the comb tooth-shape gas diffusion electrodes 28, 30, and/or the comb tooth-shape air electrode current collectors 22, 24. That is, by using such a holding member 32, the metal-air secondary battery 10 can be easily assembled by fitting the comb tooth-shape air electrode layers 12, 14, the comb tooth-shape gas diffusion electrodes 28, 30, and/or the comb tooth-shape air electrode current collectors 22, 24 into the comb tooth-shape openings 32a. Further, each of the members of the assembled metal-air secondary battery 10 can be securely fixed in place by the holding member 32. The material of the holding member 32 is not particularly limited as long as it is an insulating member, but the holding member 32 is preferably an elastic member having insulating properties, such as a rubber sheet. When a holding member 32 made of an elastic member such as a rubber sheet is used, pressure can be applied to each component of the metal-air secondary battery 10 so as to tightly adhere the composite air electrode layer 16, the separator 20, and the metal negative electrode layer 18 to one another, which has the advantage of lowering battery resistance and facilitating an improvement in the performance of the metal-air secondary battery 10. In addition, there is also the advantage that the comb tooth-shape air electrode layers 12, 14, comb tooth-shape gas diffusion electrodes 28, 30, and/or comb tooth-shape air electrode current collectors 22, 24 fitted into the holding member 32 can maintain a shape that allows gas diffusion (without excessive deformation) while maintaining suitable electron conduction and contact as a result of the elasticity of the member, such as a rubber sheet.

The metal-air secondary battery of the present disclosure may be any type of air secondary battery that uses a metal negative electrode, but a zinc-air secondary battery that uses a zinc electrode as the metal negative electrode is particularly preferred. Further, a lithium-air secondary battery including a lithium electrode as a metal negative electrode may be used.

### Examples

The present disclosure will now be explained in more detail with reference to the following examples. However, the present disclosure is not limited to the following examples.

### Example 1: Example Using a Nonwoven Fabric Separator

A metal-air secondary battery 10 having the configuration shown in FIGS. 6 to 9 that used a nonwoven fabric separator as the separator 20 was prepared and evaluated as follows.

### (1) Preparation of Charge Comb Tooth-Shape Laminated Body

A blended powder was obtained by mixing 50% by volume of carbon powder (manufactured by Tokai Carbon Co., Ltd., Toka Black #3855) and 50% by volume of LDH powder (Ni—Fe-LDH powder prepared by coprecipitation method) in a mortar. 7 parts by weight in terms of solid content of a polytetrafluoroethylene (PTFE) dispersion aqueous solution (manufactured by Daikin Industries, Ltd., solid content 60%) and 58 parts by weight of propylene glycol were added into 100 parts by weight of the blended powder and kneaded, and the mixture was then rolled using a roll press to obtain a charge air electrode layer 12 having a thickness of 0.15 mm. The obtained charge air electrode layer 12 and a charge gas diffusion electrode 28 (SIGRACET29BC) were stacked and pressed together using a uniaxial press, then dried in a vacuum dryer at 80° C. for 14 hours. After drying, the stack was processed using a laser processing machine into a comb tooth-shape in which air electrode fingers 12b had a width of 8 mm and a spacing of 16 mm between air electrode fingers 12b, to thereby obtain a charge comb tooth-shape laminated body composed of the charge air electrode layer 12 and the charge gas diffusion electrode 28.

### (2) Preparation of Discharge Comb Tooth-Shape Laminated Body

7 parts by weight in terms of solid content of a polytetrafluoroethylene (PTFE) dispersion aqueous solution (manufactured by Daikin Industries, Ltd., solid content 60%) and 58 parts by weight of propylene glycol were added into 100 parts by weight of platinum-supported carbon powder (manufactured by Toyo Corporation, EC-20-PTC) and kneaded, and the mixture was then rolled using a roll press to obtain a discharge air electrode layer 14 having a thickness of 0.15 mm. The obtained discharge air electrode layer 14 and a discharge gas diffusion electrode 30 (SIGRACET29BC) were stacked and pressed together using a uniaxial press, then dried in a vacuum dryer at 80° C. for 14 hours. After drying, the stack was processed using a laser processing machine into a comb tooth-shape in which air electrode fingers 14b had a width of 8 mm and a spacing of 16 mm between air electrode fingers 14b, to thereby obtain a discharge comb tooth-shape laminated body composed of the discharge air electrode layer 14 and the discharge gas diffusion electrode 30.

### (3) Preparation of Negative Electrode Structure

100 parts by weight of ZnO powder (manufactured by Seido Chemical Industry Co., Ltd., JIS standard type 1 grade, average particle size D50: 0.2 μm) was added to 50 parts by weight of metallic Zn powder (Mitsui Mining & Smelting Co., Ltd., doped with Bi and In, Bi: 1000 ppm by weight, In: 1000 ppm by weight, and average particle size D50: 100 μm), then 1.7 parts by weight in terms of solid content of polytetrafluoroethylene (PTFE) dispersion solution (manufactured by Daikin Industries, Ltd., solid content 60%) was further added, and the mixture was kneaded with propylene glycol. The resulting kneaded material was rolled using a roll press to obtain a negative electrode active material sheet having a thickness of 0.2 mm. The negative electrode active material sheet was arranged on both sides of tin-plated copper expanded metal, pressed, and dried in a vacuum dryer at 80° C. for 14 hours. The dried negative electrode sheet was cut out so that the portion where the active material was applied was 2 cm square, and copper foil was welded to the edges of the copper expanded metal to obtain a negative electrode structure composed of a zinc oxide negative electrode as the metal negative electrode layer 18 and copper expanded metal and copper foil as the negative electrode current collector 26.

### (4) Assembly of Evaluation Cell

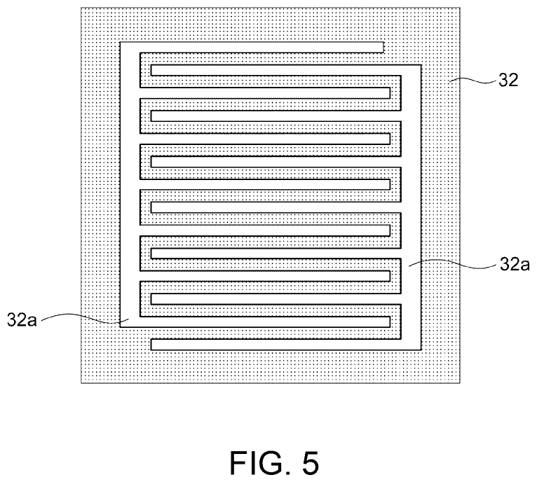

As shown in FIG. 5, a rubber sheet having two comb tooth-shape openings 32a capable of accommodating a charge comb tooth-shape laminated body and a discharge comb tooth-shape laminated body so that they are spaced apart from and interdigitated with each other was prepared as the holding member 32. The charge comb tooth-shape laminated body and a charge air electrode current collector 22 (nickel mesh) having a corresponding comb tooth-shape portion were fitted into the opening 32a of this rubber sheet, and a discharge comb tooth-shape laminated body and a discharge air electrode current collector 24 (nickel mesh) having a corresponding comb tooth-shape portion were fitted into the other opening 32a. In the obtained composite air electrode layer 16, the width W of each of the air electrode fingers 12b, 14b was 8 mm, and the separation distance D between adjacent air electrode fingers 12b, 14b was 4 mm. A nonwoven fabric (FT-7040P, manufactured by Japan Vilene Company, Ltd.) was arranged as a separator 20 on one side of the metal negative electrode layer 18, and a rubber sheet with the charge comb tooth-shape laminated body and discharge comb tooth-shape laminated body fitted therein was arranged on the side of the nonwoven fabric that was not in contact with the negative electrode structure. The resulting laminated body was clamped in a holding jig with a sealing member tightly biting into the outer periphery of the nonwoven fabric, and firmly fixed with screws. This holding jig had an oxygen inlet on the comb tooth-shape laminated body side and a liquid injection port through which an electrolytic solution could be introduced on the negative electrode structure side. A 5.4 M KOH aqueous solution saturated with zinc oxide was charged into the liquid injection port of the assembly thus obtained to form an evaluation cell.

### (5) Evaluation

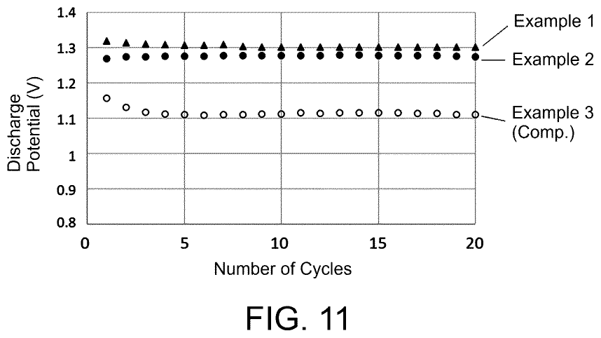

Using an electrochemical measuring device (VMP3, manufactured by Bio-Logic Science Instruments), the charge/discharge characteristics of the evaluation cell were measured under the following conditions. The results are shown in FIG. 11.
Air electrode gas: Water-vapor-saturated (25° C.) oxygen (flow rate 200 cc/min)
Charge/discharge current density: 4 mA/cm² (with respect to electrode area of the zinc oxide negative electrode)
Charge/discharge time: 60 minutes charge/60 minutes discharge
Number of cycles: 20 cycles

### Example 2: Example Using a Hydroxide Ion Conductive Separator

A metal-air secondary battery 10 with the configuration shown in FIGS. 6 to 9 that used an LDH separator as the separator 20 was prepared and evaluated as follows.

### (1) Preparation of Composite Air Electrode Layer/Separator Assembly

A blended powder was obtained by mixing 50% by volume of carbon powder (manufactured by Tokai Carbon Co., Ltd., Toka Black #3855) and 50% by volume of LDH powder (Ni—Fe-LDH powder prepared by coprecipitation method) in a mortar. 7 parts by weight of butyral resin and 80 parts by weight of butyl carbitol were added into 100 parts by weight of the blended powder and kneaded, and the mixture was kneaded with a three-roll rotation/revolution mixer (ARE-310 manufactured by Thinky Corporation) to obtain a paste. This paste was applied by screen printing onto the surface of an LDH separator (separator obtained by causing Mg—Al—Ti—Y-LDH-like compound to precipitate on the inside of the pores and the surface of a polyethylene microporous membrane by hydrothermal synthesis, and roll pressing; thickness: 20 μm) as the separator 20 to form a charge air electrode layer 12 having a comb-tooth shape with an electrode width of 10 mm and an inter-electrode distance of 20 mm. Then, before the paste was dried, a charge gas diffusion electrode 28 (SIGRACET29BC) having the same comb-tooth shape was placed on the charge air electrode layer 12. In this way, a charge comb tooth-shaped laminated body composed of the charge air electrode layer 12 and the chargeable gas diffusion electrode 28 was obtained.

A paste was obtained by adding 7 parts by weight of butyral resin and 80 parts by weight of butyl carbitol into 100 parts by weight of platinum-supported carbon powder (manufactured by Toyo Corporation, EC-20-PTC), and the mixture was kneaded with a three-roll rotation/revolution mixer (ARE-310 manufactured by Thinky Corporation) to obtain a paste. This paste was applied by screen printing onto the surface of the LDH separator 20 on which the charge air electrode layer 12 had been formed to form a discharge air electrode layer 14 having a comb-tooth shape with an electrode width of 10 mm and an inter-electrode distance of 20 mm that was spaced apart from and interdigitated with the charge air electrode layer 12. Then, before the paste was dried, a discharge gas diffusion electrode 30 (SIGRACET29BC) having the same comb-tooth shape was placed on the discharge air electrode layer 14. The obtained laminated body was placed under a weight and dried in a vacuum dryer at 80° C. for 30 minutes to form a discharge comb tooth-shape laminated body formed from the discharge air electrode layer 14 and the discharge gas diffusion electrode 30. In this way, a composite air electrode layer/separator assembly including the comb tooth-shaped composite air electrode layer 16 and the gas diffusion electrodes 28, 30 on the separator 20 was obtained.

### (2) Preparation of Negative Electrode Structure

In the same manner as in Example 1, a negative electrode structure was prepared composed of a zinc oxide negative electrode as the metal negative electrode layer 18 and copper expanded metal and Cu foil as the negative electrode current collector 26.

### (3) Assembly of Evaluation Cell

As shown in FIG. 5, a rubber sheet (fluororesin) having two comb tooth-shape openings 32a capable of accommodating a charge comb tooth-shape laminated body and a discharge comb tooth-shape laminated body so that they were spaced apart from and interdigitated with each other was prepared as the holding member 32. A charge air electrode current collector 22 and a discharge air electrode current collector 24 (both nickel meshes) having corresponding comb tooth-shape portions were each fitted into the two openings 32a of the rubber sheet, the charge air electrode current collector 22 and the discharge air electrode current collector 24 were arranged on the printed surface of the composite air electrode layer/separator assembly so that the positions of the tooth-like comb portions aligned, and then pressed together using a uniaxial press. The negative electrode structure was then laminated on the LDH separator side of the composite air electrode layer/separator assembly. The resulting laminated body was clamped in a holding jig with a sealing member tightly biting into the outer periphery of the LDH separator, and then firmly fixed with screws. This holding jig had an oxygen inlet on the comb tooth-shape laminated body side and a liquid injection port through which an electrolytic solution could be introduced on the negative electrode side. A 5.4 M KOH aqueous solution saturated with zinc oxide was charged into the liquid injection port of the assembly thus obtained to form an evaluation cell.

### (4) Evaluation

The charge/discharge characteristics of the evaluation cell were measured in the same manner as in Example 1. The results are shown in FIG. 11.

### Example 3 (Comparative Example)

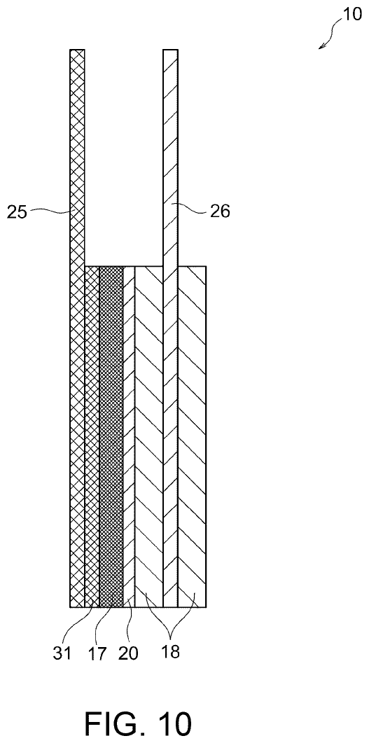

A metal-air secondary battery 10 with the configuration shown in FIG. 10 that used an LDH separator as the separator 20 and a flat plate-like charge/discharge air electrode layer 17 that did not have a comb tooth-shape was prepared and evaluated as follows.

### (1) Preparation of Air Electrode Layer/Separator Assembly

A blended powder was obtained by mixing 50% by volume of platinum-supported carbon powder (manufactured by Toyo Corporation, EC-20-PTC) and 50% by volume of LDH powder (Ni—Fe-LDH powder prepared by coprecipitation method) in a mortar. 7 parts by weight of butyral resin and 80 parts by weight of butyl carbitol were added into 100 parts by weight of the blended powder and kneaded, and the mixture was kneaded with a three-roll rotation/revolution mixer (ARE-310 manufactured by Thinky Corporation) to obtain a paste. This paste was applied by screen printing onto the surface of an LDH separator (separator obtained by causing Mg—Al—Ti—Y-LDH-like compound to precipitate on the inside of the pores and the surface of a polyethylene microporous membrane by hydrothermal synthesis, and roll pressing; thickness: 20 μm) to form a charge/discharge air electrode layer 17. Then, before the paste was dried, a gas diffusion electrode 31 (SIGRACET29BC) was placed on the air electrode layer 17. The obtained laminated body was placed under a weight and dried in a vacuum dryer at 80° C. for 30 minutes to obtain an air electrode layer/separator assembly including the air electrode layer 17, which did not have a comb tooth-shape, and the gas diffusion electrode 31 on the separator 20.

### (2) Preparation of Negative Electrode Structure

In the same manner as in Example 1, a negative electrode structure composed of a zinc oxide negative electrode as the metal negative electrode layer 18 and copper expanded metal and Cu foil as the negative electrode current collector 26 was prepared.

### (3) Assembly of Evaluation Cell

As shown in FIG. 10, an evaluation cell was assembled using the same procedure as in Example 1, except that the air electrode layer/separator assembly was laminated on one side of the negative electrode structure and that an air electrode current collector 25, which did not have a comb-tooth shape, was used.

### (4) Evaluation

The charge-discharge characteristics of the evaluation cell were measured in the same manner as in Example 1. The results are shown in FIG. 11. As can be seen from the results shown in FIG. 11, the evaluation cells according to the present disclosure prepared in Examples 1 and 2 were able to better suppress the initial deterioration associated with catalyst oxidation and exhibited a higher discharge potential than the evaluation cell prepared in Example 3 (comparative example). Further, the fact that a high discharge potential was exhibited means that an increase in overvoltage was suppressed.

What is claimed is:

1. A metal-air secondary battery comprising:
a comb tooth-shaped charge air electrode layer comprising a charge air electrode catalyst, an electrically conductive material, and a binder;
a comb tooth-shaped discharge air electrode layer that comprises a discharge air electrode catalyst, which is a carbon-based catalyst, and a binder, and that is spaced apart from and interdigitated with the comb tooth-shaped charge air electrode layer in the same plane;
a metal negative electrode layer arranged facing a composite air electrode layer composed of the charge air electrode layer and the discharge air electrode layer in the same plane;
an electrolytic solution impregnated in the metal negative electrode layer; and
a separator that is interposed between the composite air electrode layer and the metal negative electrode layer so as to be in contact with the composite air electrode layer and isolate the composite air electrode layer from the metal negative electrode layer in a manner that allows hydroxide ions to be conducted between the composite air electrode layer and the metal negative electrode layer.

2. The metal-air secondary battery according to claim 1,
wherein the metal-air secondary battery comprises a pair of the composite air electrode layers that are spaced apart from and facing each other,
the separator is interposed between each of the pair of composite air electrode layers and the metal negative electrode layer, and
the metal negative electrode layer is sandwiched between the pair of composite air electrode layers via the separator.

3. The metal-air secondary battery according to claim 1, wherein the charge air electrode catalyst is a layered double hydroxide (LDH).

4. The metal-air secondary battery according to claim 3, wherein the LDH as the charge air electrode catalyst comprises at least Ni and Fe as constituent elements.

5. The metal-air secondary battery according to claim 3, wherein the LDH as the charge air electrode catalyst comprises at least Ni, Fe, V, and Co as constituent elements.

6. The metal-air secondary battery according to claim 1,
wherein the separator is a hydroxide ion conductive separator that isolates the composite air electrode layer from the metal negative electrode layer in a manner that allows hydroxide ions to be conducted between the composite air electrode layer and the metal negative electrode layer, and
the charge air electrode layer further comprises a hydroxide ion conductive material and the discharge air electrode layer further comprises a hydroxide ion conductive material.

7. The metal-air secondary battery according to claim 6, wherein the hydroxide ion conductive separator is a layered double hydroxide (LDH) separator.

8. The metal-air secondary battery according to claim 7, wherein the LDH separator is composited with a porous substrate.

9. The metal-air secondary battery according to claim 6, wherein the hydroxide ion conductive separator blocks the electrolytic solution from penetrating into the composite air electrode layer so that the electrolytic solution is absent from the air electrode layer.

10. The metal-air secondary battery according to claim 1, further comprising:
a charge air electrode current collector that is arranged on an outer side of the charge air electrode layer and that extends from an edge of the charge air electrode layer;
a discharge air electrode current collector that is arranged on an outer side of the discharge air electrode layer and that extends from an edge of the discharge air electrode layer; and
a negative electrode current collector that supports the metal negative electrode layer and that extends from an edge of the metal negative electrode layer.

11. The metal-air secondary battery according to claim 10, further comprising:
a charge gas diffusion electrode arranged between the charge air electrode layer and the charge air electrode current collector; and
a discharge gas diffusion electrode arranged between the discharge air electrode layer and the discharge air electrode current collector.
